(19) United States
(12) Patent Application Publication
(10) Pub. No.: US 2021/0078352 A1
(43) Pub. Date: Mar. 18, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Kensuke ITO, Kanagawa (JP)

(73) Assignee: FUJI XEROX CO., LTD., Tokyo (JP)

(21) Appl. No.: 16/741,751

(22) Filed: Jan. 14, 2020

(30) Foreign Application Priority Data
Sep. 12, 2019 (JP) 2019-165912

(51) Int. Cl. B42D 25/26; B42D 25/305; B42D 25/21

(52) U.S. Cl. CPC B42D 25/26; B42D 25/21; B42D 25/305

(57) ABSTRACT

An information processing apparatus includes a storage section that stores device identification information of a terminal device authenticated to validate a printed matter, in advance, a receiving section that receives a random pattern acquired from a partial area of a surface of a printed matter intended to be validated, printed-matter identification information capable of individually identifying the printed matter, and device identification information of a terminal device that acquires the random pattern, a control section that, in a case where the device identification information received by the receiving section coincides with any piece of the device identification information stored in the storage section, controls the storage section to store the random pattern and the printed-matter identification information received by the receiving section in association with each other, and a validation section that validates the printed matter having the random pattern stored in the storage section, to be usable.

### CROSS-REFERENCE TO RELATED APPLICATIONS

This application is based on and claims priority under 35 USC 119 from Japanese Patent Application No. 2019-165912 filed Sep. 12, 2019.

### BACKGROUND

### (i) Technical Field

The present invention relates to an information processing apparatus and a non-transitory computer readable medium storing a program.

### (ii) Related Art

JP2004-153405A discloses a document verification method in which random pattern features are extracted from a printed image of a normal printed matter and are stored as feature vectors, random pattern features are extracted from a printed image of a printed matter as a verification target which is to be verified as an original document, so as to calculate feature vectors, and it is determined whether or not the printed matter as the verification target is an original document, in accordance with similarity between the calculated feature vectors and the stored feature vectors.

JP5071592B discloses an authenticity determination method of an article, in which any portion of an article is specified, an image of an identification mark printed at the specified portion of the article is stored in association with an individual article identification code, an image with an individual identification code and an identification mark read from a certain article is compared with the stored information, and thus authenticity of the article is determined based on a comparison result.

### SUMMARY

Counterfeit prevention is required so that it is not possible to easily copy printed matters such as marketable securities and tickets. Therefore, advanced counterfeit prevention techniques such as holograms, fine printing, special paper, and special ink are used for such a printed matter requiring counterfeit prevention technique.

However, such a printed matter using the advanced counterfeit prevention technique may be created only at a specific printing office in which a special printer is provided. Therefore, there is a problem in that such a printer matter is expensive and requires a creation time of some extents, and thus immediate issuing is difficult. A method in which special printing paper is prepared in advance, and printing is performed on the special printing paper is also provided, but has a problem in that management cost is required to manage such special printing paper.

Therefore, it is required to obtain such a printed matter by printing of a general printer. For example, it is required to obtain the above-described printed matter by a printer at a personal home or to print an admission ticket of a concert by a printer installed at a convenience store. In the convenience store, it is required to handle prepaid cards or tickets which has been printed in advance, such that printing is not to be performed every time, and thus cost for installing a printing machine, managing consumables, or the like is required.

However, a printed matter obtained by printing on general printing paper with a general ink and the like is easily copied. Thus, for example, in a case where printing of an admission ticket of a concert is performed by such a printing method, the identical admission ticket is output a plurality of number of times. Accordingly, the admission ticket which has been normally issued is not recognized.

Aspects of non-limiting embodiments of the present disclosure relate to an information processing apparatus and a non-transitory computer readable medium storing a program in which, in a case where a printed matter which does not use a complex counterfeit prevention technique is intended to be validated to be usable, it is possible to validate the printed matter by a terminal device including at least a shooting function and a communication function.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a storage section that stores device identification information of a terminal device authenticated to validate a printed matter, in advance, a receiving section that receives a random pattern acquired from a partial area of a surface of a printed matter intended to be validated, printed-matter identification information capable of individually identifying the printed matter, and device identification information of a terminal device that acquires the random pattern, a control section that, in a case where the device identification information received by the receiving section coincides with any piece of the device identification information stored in the storage section, controls the storage section to store the random pattern and the printed-matter identification information received by the receiving section in association with each other, and a validation section that validates the printed matter having the random pattern stored in the storage section, to be usable.

### BRIEF DESCRIPTION OF THE DRAWINGS

Exemplary embodiment(s) of the present invention will be described in detail based on the following figures, wherein:

FIG. 1 is a diagram illustrating a system configuration of an information processing system according to a first exemplary embodiment of the present invention;

FIG. 2 is a diagram illustrating an example of an admission ticket to be validated in the information processing system in the first exemplary embodiment of the present invention;

FIG. 3 is a diagram illustrating an example of a prepaid card to be validated in the information processing system in the first exemplary embodiment of the present invention;

FIG. 4 is a block diagram illustrating a hardware configuration of a management server 10 in the first exemplary embodiment of the present invention;

FIG. 5 is a block diagram illustrating a functional configuration of the management server 10 in the first exemplary embodiment of the present invention;

FIG. 6 is a diagram illustrating an example of a permission terminal management table stored in a management table storage unit 35;

FIG. 7 is a diagram illustrating an example of a random pattern management table stored in the management table storage unit 35;

FIG. 8 is a diagram illustrating an example of an admission ticket management table stored in the management table storage unit 35;

FIG. 9 is a sequence chart illustrating an operation in a case where validation processing of the admission ticket is performed between a terminal device 20 and the management server 10;

FIG. 10 is a diagram illustrating a form of determining whether or not two random patterns coincide with each other;

FIG. 11 is a diagram illustrating a form of changing a serial ID “10123456” in the admission ticket management table from “invalid” to “valid”;

FIG. 12 is a diagram illustrating a system configuration of an information processing system according to a second exemplary embodiment of the present invention;

FIG. 13 is a diagram illustrating an example of a paper wallet to be used in the information processing system in the second exemplary embodiment of the present invention;

FIG. 14 is a diagram illustrating an adapter 70 used when a random pattern is read from a reading area 51 of a paper wallet;

FIG. 15 is a diagram illustrating a form when the random pattern is read with the adapter 70; and

FIG. 16 is a sequence chart illustrating an operation in a case where remittance processing using the paper wallet is performed.

### DETAILED DESCRIPTION

Hereinafter, exemplary embodiments of the present invention will be described in detail with reference to the accompanying drawings.

### First Exemplary Embodiment

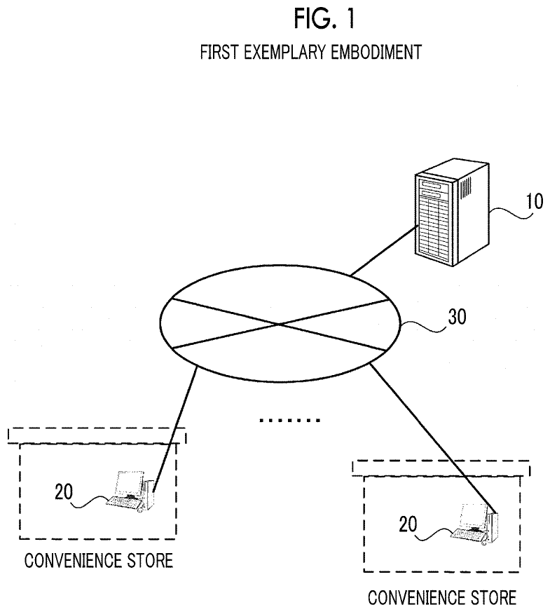

FIG. 1 is a diagram illustrating a system configuration of an information processing system according to a first exemplary embodiment of the present invention.

As illustrated in FIG. 1, the information processing system in the first exemplary embodiment of the present invention has a configuration in which a management server 10 and a plurality of terminal devices 20 installed in a convenience store are connected to each other by a network 30. Each of the plurality of terminal devices 20 is installed at a counter in the convenience store.

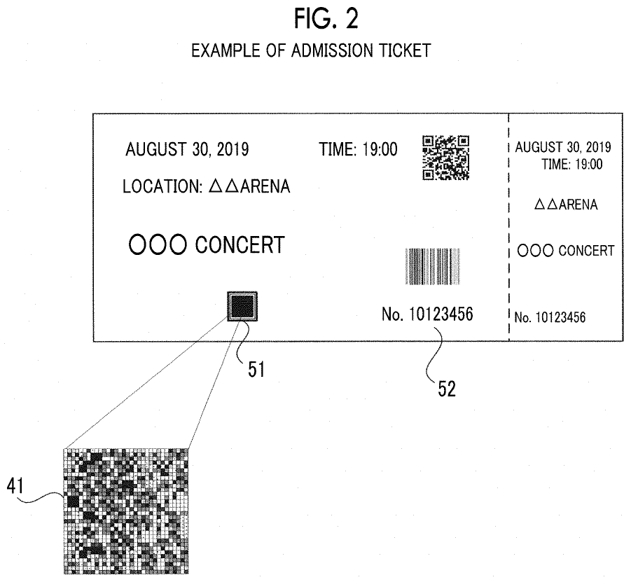

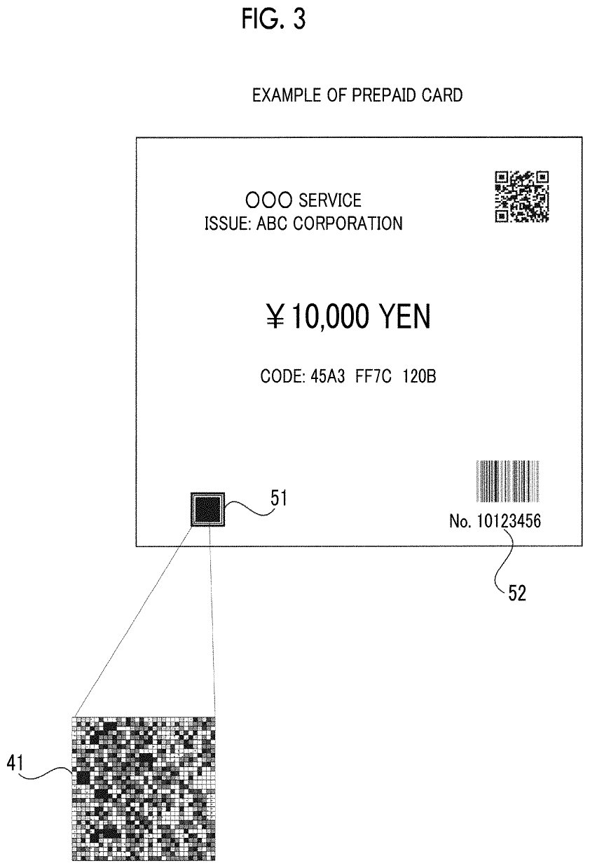

In the information processing system in the first exemplary embodiment, a case where the terminal device 20 performs validation processing of an admission ticket as illustrated in FIG. 2 or a prepaid card as illustrated in FIG. 3 will be described.

Here, the validation processing means processing of making a printed matter such as an admission ticket or a prepaid card to be in a usable state. It is assumed that it is not possible to use such a printed matter in a state where the validation processing is not performed, and it is possible to use the printed matter firstly after the validation processing is performed.

Therefore, in the convenience store, even in a case where prepaid cards before the validation processing are arranged in the front of the store to be sold, there is no need to worry about theft. That is, this is because, in order to cause the prepaid card to be usable, it is necessary to pay a prescribed fee at the counter and to cause a store clerk to perform validation processing. Therefore, even in a case where prepaid cards arranged in the front of the store are shoplifted, it is not possible to use the prepaid card, and thus to prevent being shoplifted.

As illustrated in FIGS. 2 and 3, in the admission ticket or the prepaid card in the first exemplary embodiment, a reading area 51 for reading a random pattern 41 is provided, and a serial ID 52 provided in each printed matter is printed. The serial ID 52 is printed as text information in a state of being capable of being read by a person, and the identical information is printed by a barcode being a one-dimensional code.

Here, the random pattern is a feature pattern created by fine imprinting of shading or unevenness on the surface of an object, and is a feature pattern unique to each object.

For example, a unique random pattern is provided on the surface of various objects such as paper, metal, and resin, like a human fingerprint, a vein pattern, and an iris pattern. Therefore, an image of a portion of a random pattern on the surface of an object may be acquired and registered, and a random pattern of the object shot again from the identical place may be compared to the pre-registered random pattern. Thereby, it may be determined whether or not the objects are identical to each other.

In particular, paper is made of intricately intertwined plant fibers. Thus, a random pattern may be acquired by shooting an image of a portion of the paper. Using a random pattern such as plant fiber contained in paper as a “fingerprint” for identifying paper is referred to as a paper finger print (PFP) technology. The PFP technology may be applied not only to the paper but also to an object having a random pattern on a surface of the object, for example, an object such as a blasted metal plate or a silver-coated resin plate.

In the first exemplary embodiment, descriptions will be made using a case where solid printing is performed with the identical density of black in the reading area 51, and the random pattern 41 is acquired from the black solid printing. However, printing may be not performed in the reading area 51, and a random pattern on the surface of printing paper may be acquired.

Here, the terminal device 20 installed at the counter of each convenience store includes a shooting device such as a camera, which is used for acquiring the random pattern.

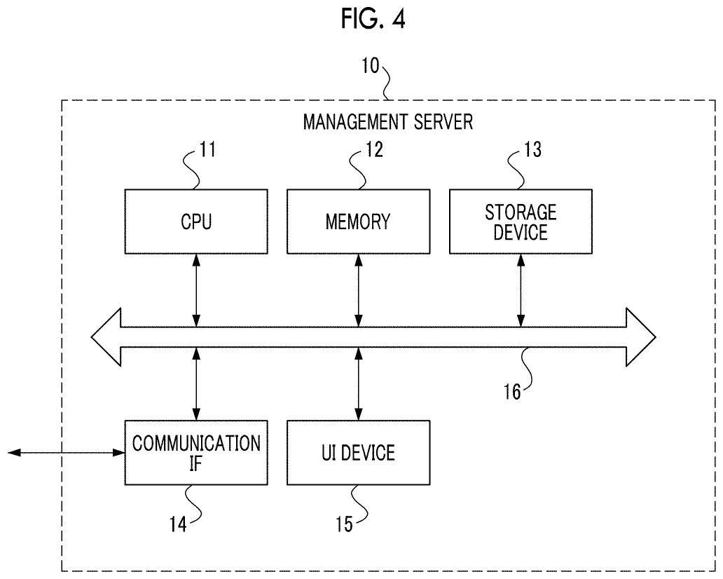

Next, FIG. 4 illustrates a hardware configuration of the management server 10 in the information processing system in the first exemplary embodiment.

As illustrated in FIG. 4, the management server 10 includes a CPU 11, a memory 12, a storage device 13 such as a hard disk drive, a communication interface (abbreviated as IF) 14 that transmits and receives data to and from an external device or the like via the network 30, and a user interface (abbreviated as a UI) device 15 including a keyboard along with a touch panel or a liquid crystal display. The components are connected to each other via a control bus 16.

The CPU 11 performs predetermined processing based on a control program stored in the memory 12 or the storage device 13 to control an operation of the management server 10. In the first exemplary embodiment, descriptions will be made on the assumption that the CPU 11 reads and executes the control program stored in the memory 12 or the storage device 13. However, the program may be stored in a storage medium such as a CD-ROM and then be provided to the CPU 11.

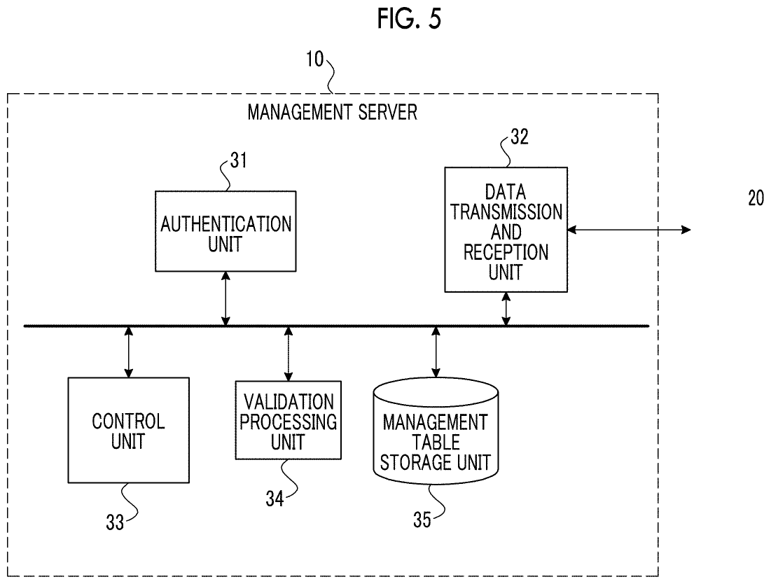

FIG. 5 is a block diagram illustrating a functional configuration of the management server 10, which is realized by executing the control program.

In the first exemplary embodiment, as illustrated in FIG. 5, the management server 10 includes an authentication unit 31, a data transmission and reception unit 32, a control unit 33, a validation processing unit 34, and a management table storage unit 35.

The authentication unit 31 authenticates an operator who operates a terminal device.

The data transmission and reception unit 32 receives a random pattern acquired from a partial area of a surface of a printed matter to be validated, printed-matter identification information capable of individually identifying the printed matter, and a terminal ID being device identification information of a terminal device that acquires the random pattern.

The management table storage unit 35 stores the terminal ID of a terminal device authenticated to validate the printed matter, in advance.

In a case where the terminal ID received by the data transmission and reception unit 32 coincides with any terminal ID stored in the management table storage unit 35, the control unit 33 controls the management table storage unit 35 to store the random pattern and the printed-matter identification information received by the data transmission and reception unit 32, in association with each other.

The validation processing unit 34 validates a printed matter having a random pattern stored in the management table storage unit 35, to be usable.

In the following descriptions, for easy description, a case where an admission ticket as illustrated in FIG. 2 is validated at the counter in a convenience store will be described.

In the information processing system in the first exemplary embodiment, various printed matters such as marketable securities, prepaid vouchers, and identification cards may be applied as the printed matter as a target of validation, in addition to the admission ticket.

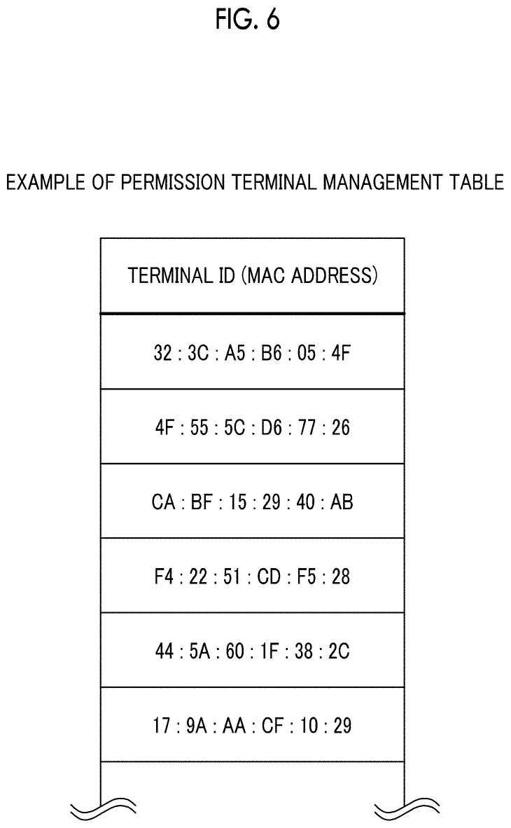

FIG. 6 illustrates an example of a permission terminal management table stored in the management table storage unit 35.

In the permission terminal management table illustrated in FIG. 6, the terminal ID being the device identification information of the terminal device authenticated to validate a printed matter is stored in advance. In the first exemplary embodiment, a case where a media access control (MAC) address is used as the terminal ID for identifying the terminal device 20 will be described. However, another kind of information may be used as the terminal ID so long as the information is capable of identifying the terminal device 20.

In the first exemplary embodiment, the MAC address of the terminal device 20 installed at the counter in a convenience store is registered in the permission terminal management table illustrated in FIG. 6, in advance.

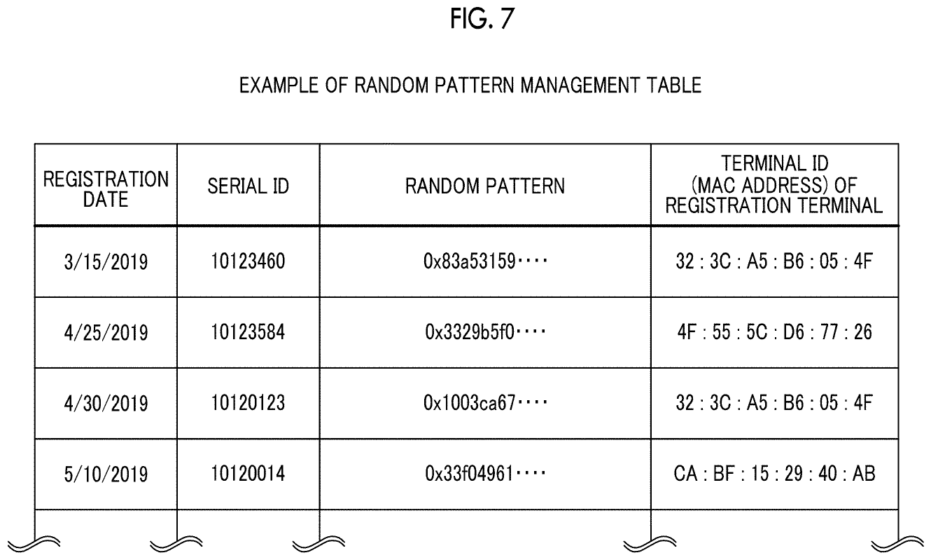

FIG. 7 illustrates an example of a random pattern management table stored in the management table storage unit 35.

In the random pattern management table illustrated in FIG. 7, a registration date, a serial ID being printed-matter identification information of an admission ticket, a random pattern acquired from the admission ticket, and a terminal ID of a registration terminal that registers the random pattern are stored in association with each other.

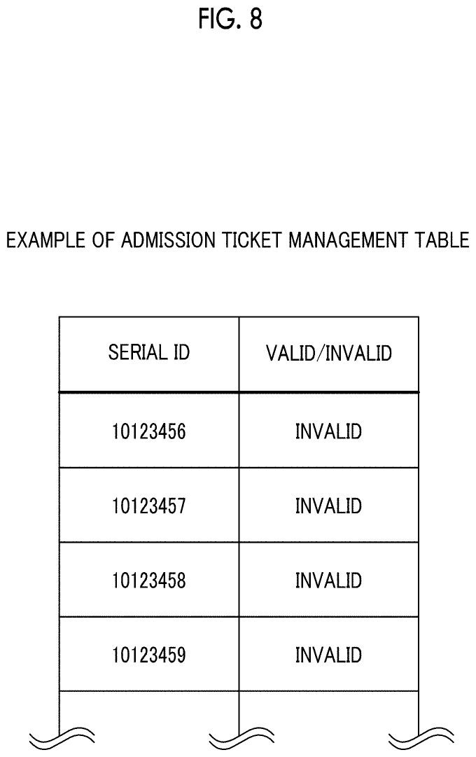

FIG. 8 illustrates an example of an admission ticket management table stored in the management table storage unit 35.

In the admission ticket management table illustrated in FIG. 8, whether an admission ticket is valid or invalid is registered for each serial ID of the admission ticket. In the admission ticket management table in FIG. 8, it is understood that the admission ticket having a serial ID “10123456” is invalid and is in a state where using is not possible.

Next, an operation of the information processing system in the first exemplary embodiment will be described in detail with reference to the drawings.

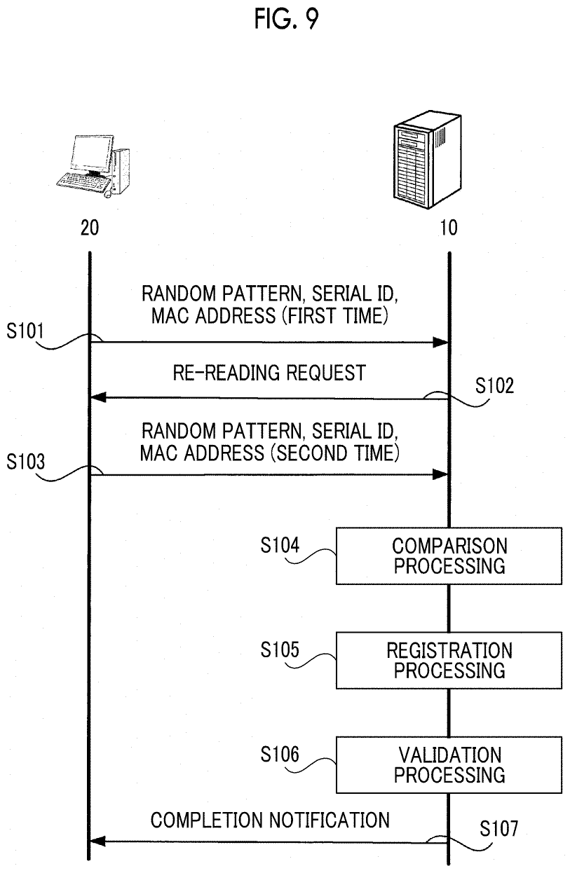

Firstly, an operation in a case where validation processing of an admission ticket is performed between the terminal device 20 and the management server 10 will be described with reference to the sequence chart in FIG. 9.

In a case where validation processing of an admission ticket is performed, in Step S101, the terminal device 20 acquires a random pattern and a serial ID of the admission ticket and transmits the random pattern and the serial ID to the management server 10 along with a MAC address of the terminal device 20.

In a case where the transmission is performed, in the management server 10, in Step S102, it is checked that the MAC address received from the terminal device 20 is registered in the permission terminal management table, and then a request of re-reading the random pattern is transmitted to the terminal device 20.

In a case where the request is transmitted, in Step S103, the terminal device 20 acquires the random pattern and the serial ID from the admission ticket to be validated, again. Then, the terminal device 20 transmits the random pattern and the serial ID to the management server 10 along with the MAC address of the terminal device 20.

In Step S104, the management server 10 that have received two random patterns perform comparison processing of checking whether or not the two random patterns coincide with each other.

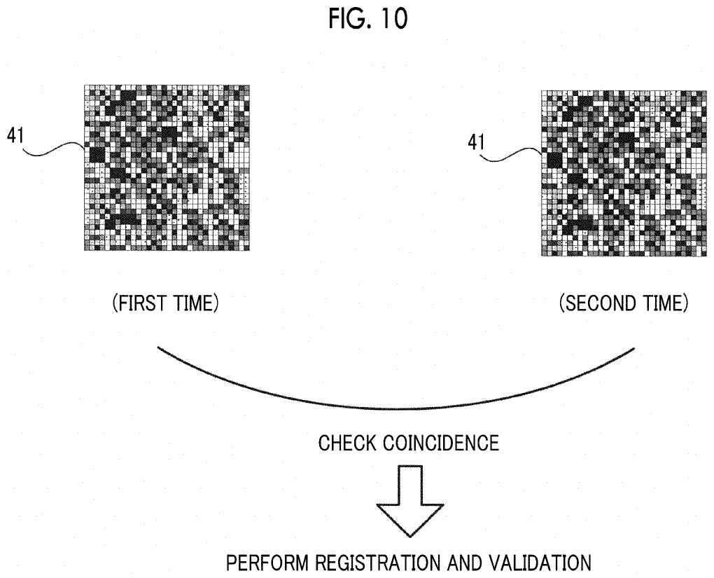

For example, as illustrated in FIG. 10, the management server 10 calculates a correlation coefficient (or correlation value, similarity) by performing correlation calculation of a density value for each pixel in the two random patterns. In a case where the correlation coefficient is equal to or more than a preset value, the management server 10 determines that the two random patterns coincide with each other.

In a case where it is determined that the two random patterns coincide with each other, the management server 10 registers the random pattern, the serial ID, and the MAC address, which have been received first time, in the random pattern management table in Step S105.

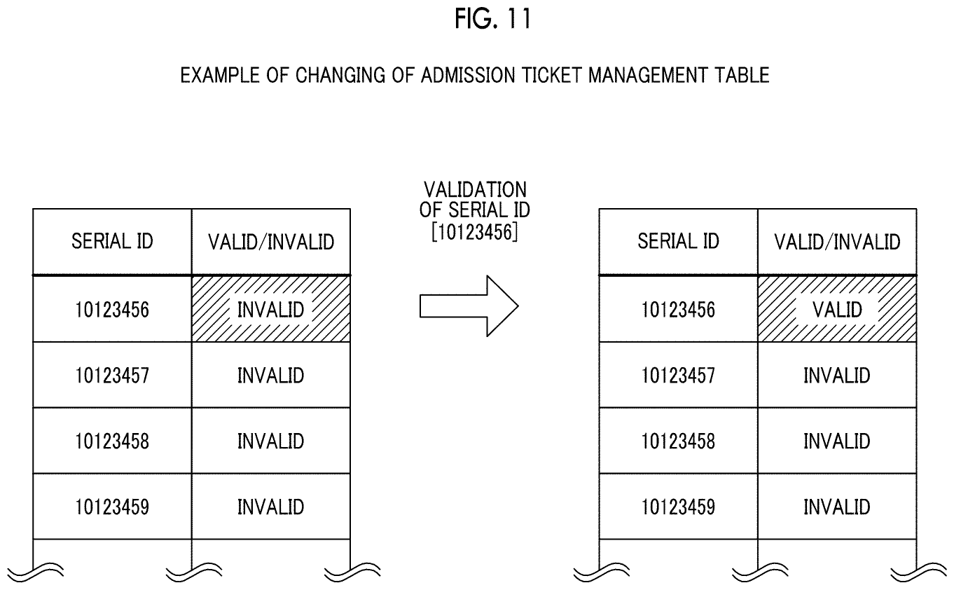

In Step S106, the management server 10 performs validation processing of an admission ticket having the serial ID. Specifically, as illustrated in FIG. 11, the admission ticket having a serial ID “10123456” is validated in a manner that the management server 10 changes the serial ID “10123456” in the admission ticket management table stored in the management table storage unit 35 from “invalid” to “valid”.

In the first exemplary embodiment, the descriptions are made using a configuration in a case where the management server manages validity/invalidity of the admission ticket. However, a server that manages validity/invalidity of the admission ticket may be separately provided.

Finally, in Step S107, the management server 10 notifies the terminal device 20 that validation processing of the admission ticket is normally performed.

The admission ticket in this manner is validated to be usable, and the acquired random pattern is registered in the random pattern management table along with the serial ID. Therefore, even in a case where the admission ticket is illegally copied, it is possible to recognize the admission ticket which has been normally issued.

That is, it is possible to determine that an admission ticket in which the random pattern acquired from the admission ticket as a determination target coincides with the random pattern registered in the random pattern management table stored in the management server 10 is the admission ticket which has been normally issued.

### Second Exemplary Embodiment

Next, an information processing system according to a second exemplary embodiment of the present invention will be described.

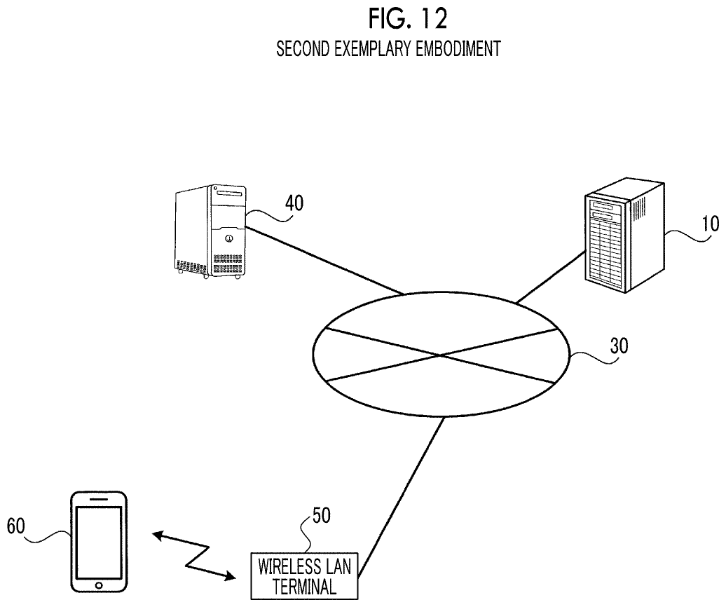

FIG. 12 is a diagram illustrating a system configuration of an information processing system according to the second exemplary embodiment of the present invention.

As illustrated in FIG. 12, the information processing system in the second exemplary embodiment of the present invention has a configuration in which a management server 10, a portable terminal device 20 such as a smart phone, and a virtual currency exchange server 40 are connected t each other by a network 30. The terminal device 20 is configured to be connected to the network 30 through a wireless LAN terminal 50.

The information processing system in the second exemplary embodiment provides a function to perform remittance processing with a virtual currency (or may be referred to as a crypto-asset).

In virtual currency, remittance processing and balance management are performed using a virtual currency address (simply expressed as an address below) and a secret key. Here, the address in the virtual currency corresponds to an account number in the bank deposit. The secret key is information for performing remittance of the virtual currency registered in the address to another address. That is, in a case where even a third party knows the address and the secret key, the virtual currency registered in the address may be transferred to another address without permission.

Therefore, it is necessary to strictly manage information of the address and the secret key. A management method of such an address and a secret key is called as a wallet, and various methods are used.

One of the wallets is a management method called as a cold wallet. The cold wallet means a wallet of managing the address and the secret key of the virtual currency in an environment which is completely separated from the Internet. It is possible to safely manage the virtual currency by using such a cold wallet. Here, as the type of cold wallet, a paper wallet in which the secret key is described on paper and a hardware wallet in which the secret key is managed by metal, coins, a secure dedicated device, or the like are provided.

In the second exemplary embodiment, a case where remittance processing of the virtual currency is performed with such a paper wallet will be described.

In the paper wallet, information of a virtual currency address and information of a secret key are printed on physical printing paper and are managed. Therefore, even an individual may create a paper wallet with a general printer at home. However, such a paper wallet may be easily copied and have no counterfeit prevention because the paper wallet is obtained by just printing on general printing paper.

In the information processing system in the second exemplary embodiment, even in a case where the paper wallet is copied by a malicious third party without permission, illegal transfer by the third party is prevented.

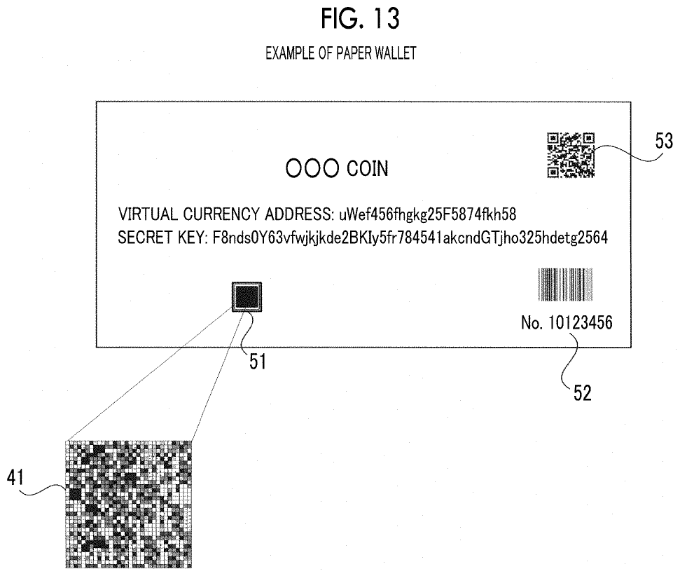

FIG. 13 illustrates an example of a paper wallet used in the second exemplary embodiment.

A reading area 51 for reading a random pattern 41, a serial ID 52, and a 2D code 53 obtained by encoding address information and a secret key in a virtual currency are printed on a paper wallet illustrated in FIG. 13.

In the information processing system in the second exemplary embodiment, processing of registering the random pattern 41 and the serial ID 52 of the paper wallet, and the MAC address as illustrated in FIG. 3 in association with each other is similar to the processing in a case of the above-described first exemplary embodiment, and thus the descriptions will not be repeated.

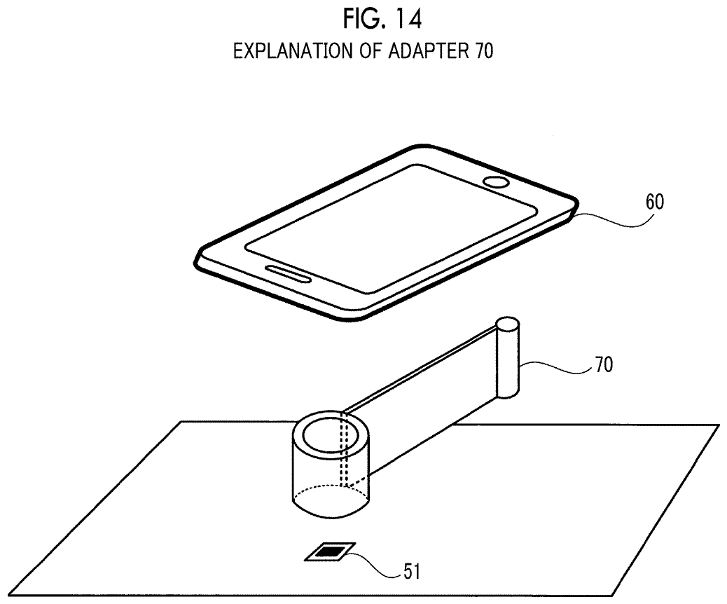

Next, an adapter 70 used in a case where the random pattern is read from the reading area 51 of the paper wallet will be described with reference to FIG. 14.

As illustrated in FIG. 14, the adapter 70 is used in a case where a terminal device 60 such as a smart phone acquires the random pattern from the reading area 51.

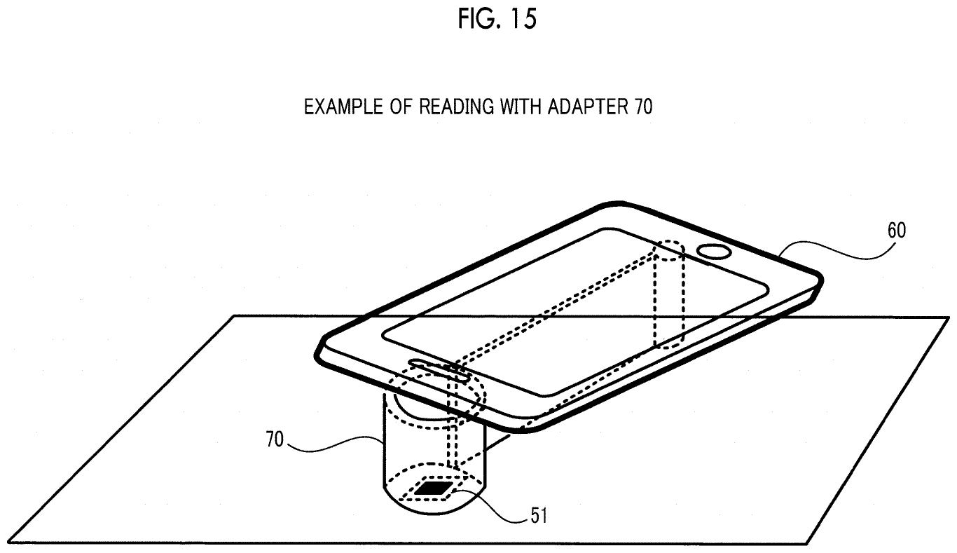

FIG. 15 illustrates a form when the random pattern is read with the adapter 70. Since the adapter 70 is used in a case where the random pattern of the reading area 51 is shot by a camera included in the terminal device 60, it is possible to perform positioning of a shooting place and to cause a distance between the camera and the reading area 51 to be constant. That is, it is possible to stably acquire an image of the random pattern by acquiring the random pattern with the adapter 70.

In the second exemplary embodiment, a data transmission and reception unit 32 receives a random pattern of a printed matter to be registered, two times in a case where such a paper wallet is validated.

In a case where the two received random patterns coincide with each other, the control unit 33 controls the management table storage unit 35 to store the random pattern in the random pattern management table.

In a case where the terminal ID of the terminal device that acquires the random pattern first time is identical to the terminal ID of the terminal device that acquires the random pattern second time, the control unit 33 determines whether or not the two received random patterns coincide with each other. That is, in a case where the terminal ID of the terminal device that acquires the random pattern first time is different from the terminal ID of the terminal device that acquires the random pattern second time, the control unit 33 does not determine whether or not the two received random patterns coincide with each other.

In a case where all the terminal ID of the terminal device that acquires the random pattern first time and the terminal ID of the terminal device that acquires the random pattern second time are stored in the permission terminal management table of the management table storage unit 35 in advance, the control unit 33 determines whether or not the two received random patterns coincide with each other.

In a case where position information of the terminal device that acquires the random pattern first time and position information of the terminal device that acquires the random pattern second time are within a preset distance, the control unit 33 may determine whether or not the two received random patterns coincide with each other.

In a case where an operator of the terminal device is authenticated by the authentication unit 31, and the operator of the terminal device that acquires the random pattern first time is identical to the operator of the terminal device that acquires the random pattern second time, the control unit 33 may determine whether or not the two received random patterns coincide with each other.

In a case where the validated printed matter is to be used, the data transmission and reception unit 32 receives the random pattern and the serial ID of the printed matter. Thus, in a case where the random pattern and the serial ID acquired from the printed matter coincide with the random pattern and the serial ID stored in the random pattern management table of the management table storage unit 35, the control unit 33 permits using of the printed matter.

In a case where the random pattern and the serial ID are stored in association with each other, the management table storage unit 35 stores the terminal ID of the terminal device that acquires the random pattern together.

Further, in a case where the validated printed matter is to be used, the data transmission and reception unit 32 receives the terminal ID of a terminal device used when the random pattern is acquired from the printed matter, from the virtual currency exchange server 40. In a case where the terminal ID received by the data transmission and reception unit 32 coincides with the terminal ID stored in association with the serial ID and the random pattern of a printed matter to be used, in the management table storage unit 35, the control unit 33 permits using of the printed matter.

The management table storage unit 35 may store the terminal ID of a terminal device that transmits print data for obtaining a printed matter, in the permission terminal management table as the terminal ID of the terminal device authenticated to validate the printed matter.

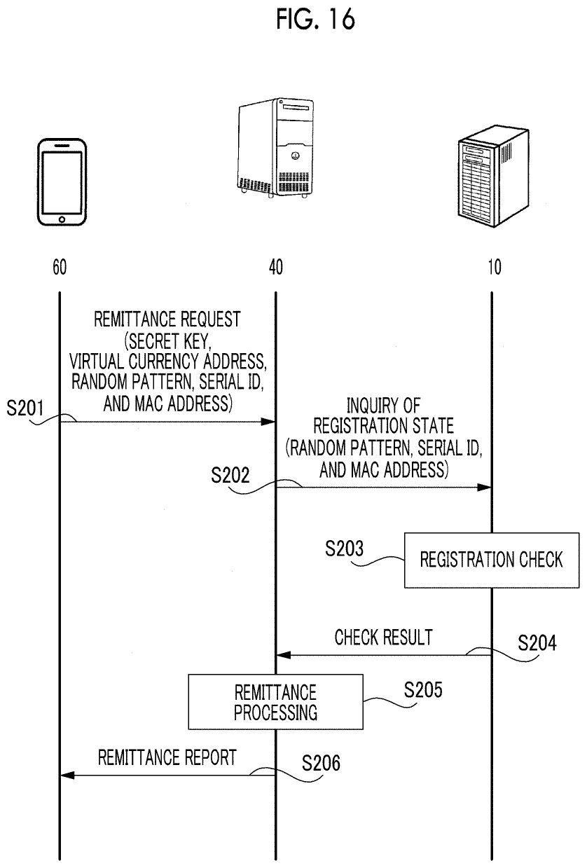

Next, an operation in a case where remittance processing using the paper wallet as illustrated in FIG. 13 is performed will be described with reference to the sequence chart in FIG. 16.

Firstly, in Step S201, the terminal device 60 transmits a secret key, a virtual currency address, a random pattern, and a serial ID which have been read from a paper wallet to the virtual currency exchange server 40 along with a MAC address of the terminal device 60, so as to require remittance.

In a case where the remittance is required, in Step S202, the virtual currency exchange server 40 which have received the remittance request from the terminal device 60 transmits information of the random pattern, the serial ID, and the MAC address included in the received remittance request to the management server 10 and transmits an inquiry of whether or not the information of the random pattern and the like is registered.

In the management server 10, in a case of receiving the inquiry, in Step S203, it is checked whether or not the random pattern as a target of the inquiry is registered in the random pattern management table stored in the management table storage unit 35. In a case of the registration check processing, determination that the random pattern is registered is not performed so long as the received information does not completely coincide with the combination of three being the random pattern, the serial ID, and the MAC address.

In a case where such registration check processing is completed, the management server 10 notifies the virtual currency exchange server 40 of a check result in Step S204.

Here, in a case where a check result indicating that the random pattern as the target of the inquiry coincides with the registered information is received, the virtual currency exchange server 40 performs processing of transferring the amount of money designated in the remittance request in Step S201 to the designated virtual currency address.

Finally, in Step S206, the virtual currency exchange server 40 reports a result obtained by performing remittance processing to the terminal device 60, and then ends the processing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a storage section that stores device identification information of a terminal device authenticated to validate a printed matter, in advance;
a receiving section that receives a random pattern acquired from a partial area of a surface of a printed matter intended to be validated, printed-matter identification information capable of individually identifying the printed matter, and device identification information of a terminal device that acquires the random pattern;
a control section that, in a case where the device identification information received by the receiving section coincides with any piece of the device identification information stored in the storage section, controls the storage section to store the random pattern and the printed-matter identification information received by the receiving section in association with each other; and
a validation section that validates the printed matter having the random pattern stored in the storage section, to be usable.

2. The information processing apparatus according to claim 1,
wherein the receiving section receives the random pattern of the printed matter to be registered, twice, and
in a case where the two received random patterns coincide with each other, the control section controls the storage section to store the random pattern.

3. The information processing apparatus according to claim 2,
wherein, in a case where the device identification information of the terminal device that acquires the random pattern first time is identical to the device identification information of the terminal device that acquires the random pattern second time, the control section determines whether or not the two received random patterns coincide with each other.

4. The information processing apparatus according to claim 2,
wherein, in a case where both the device identification information of the terminal device that acquires the random pattern first time and the device identification information of the terminal device that acquires the random pattern second time are stored in the storage section in advance, the control section determines whether or not the two received random patterns coincide with each other.

5. The information processing apparatus according to claim 2,
wherein, in a case where position information of the terminal device that acquires the random pattern first time and position information of the terminal device that acquires the random pattern second time are within a preset distance, the control section determines whether or not the two received random patterns coincide with each other.

6. The information processing apparatus according to claim 2, further comprising:
an authentication section that authenticates an operator who operates the terminal device,
wherein, in a case where an operator of the terminal device that acquires the random pattern first time is identical to an operator of the terminal device that acquires the random pattern second time, the control section determines whether or not the two received random patterns coincide with each other.

7. The information processing apparatus according to claim 1,
wherein, in a case where a validated printed matter is to be used, the receiving section receives the random pattern and the printed-matter identification information of the printed matter, and
the information processing apparatus further comprises:
a permission section that, in a case where the random pattern and the printed-matter identification information acquired from the printed matter coincide with the random pattern and the printed-matter identification information stored in the storage section, permits using of the printed matter.

8. The information processing apparatus according to claim 7,
wherein, in a case where the random pattern and the printed-matter identification information are stored in association with each other, the storage section stores the device identification information of the terminal device that acquires the random pattern together,
in a case where a validated printed matter is to be used, the receiving section receives device identification information of a terminal device used when the random pattern is acquired from the printed matter, and
in a case where the device identification information received by the receiving section coincides with the device identification information stored in the storage section in association with the printed-matter identification information and the random pattern of the printed matter to be used, the permission section permits using of the printed matter.

9. The information processing apparatus according to claim 1,
wherein the storage section stores device identification information of a terminal device that transmits print data for obtaining the printed matter, as the device identification information of the terminal device authenticated to validate the printed matter.

10. The information processing apparatus according to claim 1,
wherein the printed matter is any one of marketable securities, a prepaid voucher, an admission ticket, and an identification card.

11. The information processing apparatus according to claim 2,
wherein the printed matter is any one of marketable securities, a prepaid voucher, an admission ticket, and an identification card.

12. The information processing apparatus according to claim 3,
wherein the printed matter is any one of marketable securities, a prepaid voucher, an admission ticket, and an identification card.

13. The information processing apparatus according to claim 4,
wherein the printed matter is any one of marketable securities, a prepaid voucher, an admission ticket, and an identification card.

14. The information processing apparatus according to claim 5,
wherein the printed matter is any one of marketable securities, a prepaid voucher, an admission ticket, and an identification card.

15. The information processing apparatus according to claim 6,
wherein the printed matter is any one of marketable securities, a prepaid voucher, an admission ticket, and an identification card.

16. The information processing apparatus according to claim 7,
wherein the printed matter is any one of marketable securities, a prepaid voucher, an admission ticket, and an identification card.

17. The information processing apparatus according to claim 8,
wherein the printed matter is any one of marketable securities, a prepaid voucher, an admission ticket, and an identification card.

18. The information processing apparatus according to claim 9,
wherein the printed matter is any one of marketable securities, a prepaid voucher, an admission ticket, and an identification card.

19. A non-transitory computer readable medium storing a program causing a computer to perform:
storing device identification information of a terminal device authenticated to validate a printed matter, in advance;
receiving a random pattern acquired from a partial area of a surface of a printed matter intended to be validated, printed-matter identification information capable of individually identifying the printed matter, and device identification information of a terminal device that acquires the random pattern;
in a case where the device identification information received by the receiving coincides with any piece of the device identification information stored in the storing, controlling the storage section to store the random pattern and the printed-matter identification information received by the receiving in association with each other; and
validating the printed matter having the stored random pattern to be usable.

20. An information processing apparatus comprising:
storage means for storing device identification information of a terminal device authenticated to validate a printed matter, in advance;
receiving means for receiving a random pattern acquired from a partial area of a surface of a printed matter intended to be validated, printed-matter identification information capable of individually identifying the printed matter, and device identification information of a terminal device that acquires the random pattern;
control means for, in a case where the device identification information received by the receiving means coincides with any piece of the device identification information stored in the storage means, controlling the storage means to store the random pattern and the printed-matter identification information received by the receiving means in association with each other; and
validation means for validating the printed matter having the random pattern stored in the storage means, to be usable.
